(19) United States
(12) Patent Application Publication
(10) Pub. No.: US 2026/0182628 A1
(43) Pub. Date: Jul. 2, 2026

(54) AEROSOL GENERATING DEVICE

(71) Applicant: KT&G Corporation, Daejeon (KR)

(72) Inventors: Hanyong LEE, Daejeon (KR); Jungho Kim, Daejeon (KR); Seowon Song, Daejeon (KR); Younji Shin, Daejeon (KR); Byungsung Cho, Daejeon (KR)

(73) Assignee: KT&G Corporation, Daejeon (KR)

(21) Appl. No.: 19/331,286

(22) Filed: Sep. 17, 2025

(30) Foreign Application Priority Data
Dec. 31, 2024 (KR) 10-2024-0201742

(51) Int. Cl. A24F 40/10; A24F 40/46; A24F 40/51

(52) U.S. Cl. CPC A24F 40/10; A24F 40/46; A24F 40/51

(57) ABSTRACT

An aerosol generating device includes an insertion space into which at least a part of an aerosol generating article is inserted, a source unit configured to generate a radio frequency (RF) signal, a radiation unit configured to radiate the RF signal in a form of an electromagnetic wave toward the aerosol generating article inserted in the insertion space, a liquid reservoir storing a liquid composition, a pump configured to supply the liquid composition from the liquid reservoir to the insertion space, and a processor configured to control operations of the source unit and the pump.

### CROSS-REFERENCE TO RELATED APPLICATIONS

This application is based on and claims priority under 35 U.S.C. § 119 to Korean Patent Application No. 10-2024-0201742, filed on Dec. 31, 2024, in the Korean Intellectual Property Office, the disclosure of which is incorporated by reference herein in its entirety.

### BACKGROUND

### 1. Field

The disclosure relates to an aerosol generating device, and more particularly, to an aerosol generating device that heats an aerosol generating article by radiating an RF (radio frequency) signal in the form of an electromagnetic wave to the aerosol generating article.

### 2. Description of the Related Art

Recently, the demand for alternative methods to overcome the shortcomings of general cigarettes has increased. For example, there is a growing demand for systems in which aerosols are generated by heating cigarettes or aerosol generating materials by using aerosol generating devices, rather than methods of generating aerosols by burning cigarettes.

General aerosol generating devices mainly use a method of heating materials through electrical resistance. However, recently, a technology of heating aerosol generating articles in a non-contact manner by radiating RF signals in the form of an electromagnetic wave to the aerosol generating articles has been proposed.

### SUMMARY

In order to greatly increase the heating efficiency of an aerosol generating article, electromagnetic wave resonance has to occur in an insertion space into which the aerosol generating article is inserted.

In addition, a resonance frequency, which satisfies a resonance condition of an insertion space, may change depending on factors, such as the amount of dielectric material included in an inserted aerosol generating article.

During operation of an aerosol generating device, the resonance frequency of an insertion space may vary as the amount of dielectric material included in an aerosol generating article is consumed by microwave heating. In order to satisfy a resonance condition of an insertion space, the frequency of an electromagnetic wave radiated to an aerosol generating article has to be continuously adjusted. However, when adjusting a frequency, impedance matching between a source unit generating an RF signal and a radiation unit radiating an electromagnetic wave may not be done due to a change in frequency. When the impedance matching is not done, reflection loss between the source unit generating an RF signal and the radiation unit radiating an electromagnetic wave increases, heating efficiency of an aerosol generating article decreases, and the source unit generating the RF signal may overheat.

Considering the decreased heating efficiency of an aerosol generating article and the overheating of a source unit, adjusting the frequency of an electromagnetic wave radiated to the aerosol generating article to satisfy a resonance condition is limited. Therefore, a technology is needed to maintain the frequency satisfying a resonance condition of an insertion space at a target value.

The disclosure provides an aerosol generating device that may maintain the frequency satisfying a resonance condition of an insertion space at a target value by supplying a liquid composition to the insertion space based on capacitance of the insertion space and the reflectance of a microwave during operation of the aerosol generating device.

The technical issues of the disclosure are not limited to those described above, and other technical issues may be inferred from the following examples.

Additional aspects will be set forth in part in the description which follows and, in part, will be apparent from the description, or may be learned by practice of the presented embodiments of the disclosure.

An aerosol generating device according to an embodiment includes an insertion space into which at least a part of an aerosol generating article is inserted, a source unit configured to generate a radio frequency (RF) signal, a radiation unit configured to radiate the RF signal in a form of an electromagnetic wave toward the aerosol generating article inserted in the insertion space, a liquid reservoir storing a liquid composition, a pump configured to supply the liquid composition from the liquid reservoir to the insertion space, and a processor configured to control operations of the source unit and the pump.

### BRIEF DESCRIPTION OF THE DRAWINGS

The above and other aspects, features, and advantages of certain embodiments of the disclosure will be more apparent from the following description taken in conjunction with the accompanying drawings, in which:
FIF. 1 is a block diagram of an aerosol generating device according to an embodiment;

FIG. 2 is a cross-sectional view of an aerosol generating device according to an embodiment;

FIG. 3 is a flowchart illustrating a method of controlling an operation of an aerosol generating device according to an embodiment; and

FIG. 4 is a flowchart illustrating a method of controlling an operation of an aerosol generating device according to another embodiment.

### DETAILED DESCRIPTION

Hereinafter, embodiments will be described in detail with reference to the accompanying drawings, and the same or similar components will be assigned the same reference numerals regardless of the reference numerals in the drawings, and the same descriptions thereof will be omitted. With regard to the description of the drawings, like reference numerals may be used to represent like or related elements.

The suffixes “module”, “unit”, “-er”, and “-or” for the components used in the following description are given or used interchangeably by considering only the ease of writing the description, and do not have distinct meanings or roles in themselves. The suffix “module” or “unit”, as used herein, may include a unit implemented as hardware, software, or firmware. For example, the suffix “module” or “unit” may be interchangeably used with the term a “logic”, a “logical block”, a “component”, or a “circuit”. The “module” or “unit” may be an integrally formed component, a minimum unit of the component performing one or more functions, or a part of the minimum unit. For example, the “module” or “unit” may be implemented in the form of an application-specific integrated circuit (ASIC).

In addition, when describing the embodiments of the disclosure, the detailed description of the related known art, which may obscure the subject matter of the embodiments, may be omitted. Also, the accompanying drawings are only intended to facilitate understanding of the embodiments described herein, and the spirit of the disclosure is not limited by the accompanying drawings and should be understood to include all changes, equivalents or alternatives included in the spirit and scope of the disclosure.

Although the terms first, second, etc. may be used herein to describe various elements or components, these elements or components should not be limited by these terms. These terms are only used to distinguish one element or component from another element or component.

When an element is referred to as being “connected to” or “coupled to” another element, it may be directly connected or coupled to the other element or intervening elements may be present. In contrast, when an element is referred to as being “directly connected to” or “directly coupled to” another element, there are no intervening elements present.

The singular forms are intended to include the plural forms as well, unless the context clearly indicates otherwise.

Various embodiments of the present disclosure may be implemented as software including one or more instructions stored in a storage medium (e.g., a memory) readable by a machine (e.g., an aerosol generating device 1). For example, a processor (e.g., the processor 170) of the machine (e.g., the aerosol generating device 1) may call at least one instruction among one or more instructions stored from the storage medium and execute the at least one instruction. This makes it possible for the machine to be operated to perform at least one function according to the called at least one instruction. Examples of the one or more instructions may include codes created by a compiler, or codes executable by an interpreter. A machine-readable storage medium may be provided as a non-transitory storage medium. The ‘non-transitory storage medium’ is a tangible device and only means that it does not contain a signal (e.g., electromagnetic waves). This term does not distinguish a case in which data is stored semi-permanently in a storage medium from a case in which data is temporarily stored.

FIG. 1 is a block diagram of an aerosol generating device 1 according to an embodiment.

According to an embodiment, the aerosol generating device 1 may include a control unit 10, a source unit 20, and a radiating unit 30. The control unit 10 may refer to a circuit for controlling the basic operation of the aerosol generating device 1. The source unit 20 may refer to a circuit for generating a radio frequency (RF) signal under the control by the control unit 10. The radiating unit 30 may be a device for radiating an RF signal generated by the source unit 20 in the form of electromagnetic waves into a space into which an aerosol-generating article is inserted (hereinafter, “insertion space”). Charges or ions of a dielectric (e.g., glycerin) included in an aerosol-generating article may vibrate or rotate due to radiated electromagnetic waves (e.g., RF signals), and the aerosol-generating article may be heated as the dielectric generates heat due to frictional heat generated in the process of the charges or ions vibrating or rotating. In other words, the aerosol generating device 1 may be a device that generates an aerosol by heating an aerosol-generating article in a dielectric heating manner.

In an embodiment, the control unit 10 may include a power connector 110, a charging circuit 120, a power supply 130, a first power converter 140, a second power converter 150, a third power converter 160, and/or a processor 170. Additionally, the source unit 20 may include an RF signal generation circuit 210, a drive amplifier 220, a power amplifier 230, a directional coupler 240, and/or a temperature sensing circuit 250. However, it will be understood by those skilled in the art related to the present embodiment that some of the components illustrated in FIG. 1 may be omitted or new components may be added according to the design of the aerosol generating device 1.

The power connector 110 may refer to a physical connection device that is electrically connected to an electronic device or system (e.g., an external power supply) outside the aerosol generating device 1 and used to transmit and receive power. For example, the power connector 110 may receive power from an external power supply and transmit the received power to a component requiring charging (e.g., the power supply 130). The power connector 110 may also provide a path for data transmission. In this case, the power connector 110 may be referred to as a data and power connector. The aerosol generating device 1 may transmit and receive data to or from an external electronic device or system (e.g., a smartphone, a computer, etc.) through the power connector 110. The power connector 110 may include a Universal Serial Bus (USB) power connector, a direct current (DC) power connector, etc. In an example, the power connector 110 may include, but is not limited to, a USB-C type connector capable of supplying 9 V of direct current (DC) voltage at a current of 1 A. The power connector 110 may also include an interface for transmitting and receiving power wirelessly.

The charging circuit 120 may refer to a circuit for charging the power supply 130. The charging circuit 120 may charge the power supply 130 by using power transmitted from the power connector 110. In an example, the charging circuit 120 may be implemented as a charger IC, which is an integrated circuit (IC) that performs functions for efficiently and safely charging the power supply 130. The charging circuit 120 may monitor the charging status of the power supply 130 or optimize the charging process by monitoring the voltage, current, and/or temperature of the power supply 130. For example, the charging circuit 120 may detect the status of the power supply 130 and prevent overcharging or overdischarging by providing an appropriate charging voltage and current.

The power supply 130 may supply power for the operation of the aerosol generating device 1. The power supply 130 may include one or more rechargeable batteries. The power supply 130 may supply power to the radiating unit 30 such that the radiating unit 30 may radiate electromagnetic waves (e.g., RF signals) into the insertion space to heat an aerosol-generating article. Here, power supply to the radiating unit 30 may indicate power supply to the source unit 20. Additionally, the power supply 130 may supply power required for the operation of the processor 170, the RF signal generation circuit 210, the drive amplifier 220, the power amplifier 230, the temperature sensing circuit 250, etc. In an example, the power supply 130 may include, but is not limited to, a lithium polymer (LiPoly) battery. The power supply 130 may be a replaceable type (separated type) battery (hereinafter, a removable battery). The removable battery may be mounted in a battery holder provided within the aerosol generating device 1 or removed from the battery holder. The removable battery may be charged in a wired manner and/or wirelessly.

The aerosol generating device 1 may include a power conversion circuit for converting power supplied from the power supply 130 into power (e.g., voltage and/or current) suitable for other components. The power conversion circuit may include at least one of a buck converter, a buck-boost converter, a boost converter, a Zener diode, and a low-dropout (LDO) regulator. Additionally, the power conversion circuit may include a DC/AC converter (e.g., an inverter) as required.

In an example, the aerosol generating device 1 may include the first power converter 140, the second power converter 150, and the third power converter 160. The first power converter 140 may be an LDO regulator for supplying power (e.g., a DC of 3.3 V) suitable for the processor 170, the second power converter 150 may be a buck-boost converter for supplying power (e.g., a DC of 5 V) suitable for the temperature sensing circuit 250, the RF signal generation circuit 210, and the drive amplifier 220, and the third power converter 160 may be a boost converter for supplying power (e.g., a DC of 12 V/25 W) suitable for the power amplifier 230.

However, the first power converter 140, the second power converter 150, and the third power converter 160 are not limited to the examples described above and may include other types of power conversion circuits. Additionally, although FIG. 1 illustrates the aerosol generating device 1 including three power converters, the aerosol generating device 1 may include more than three power converters or may include fewer power converters. In an example, at least some of the first power converter 140, the second power converter 150, and the third power converter 160 may be integrated into a single power converter.

The processor 170 may control the overall operation of the aerosol generating device 1. For example, the processor 170 may directly or indirectly control charging and discharging of the power supply 130 by using the charging circuit 120. Additionally, the processor 170 may control the voltage and/or current output by a power conversion circuit by controlling the frequency and/or duty ratio of a current pulse input to at least one switching element of the power conversion circuit. In addition to the components described above, the processor 170 may also control the overall operation of other components to be described later.

The processor 170 may be implemented as an array of multiple logic gates, or may be implemented as a combination of a general-purpose microcontroller unit (MCU) (or microprocessor) and a memory storing a program that may be executed in the MCU. Additionally, it will be understood by those skilled in the art that the processor 170 may be implemented in other forms of hardware.

The RF signal generation circuit 210 may generate an RF signal based on power delivered from the power supply 130 or the second power converter 150. An RF signal may refer to a signal having a frequency within a range of about 300 MHz to about 300 GHz. In an example, the RF signal may have a frequency of about 1 GHz to about 100 GHz. Additionally, the RF signal may have a frequency in the Industrial Scientific and Medical equipment (ISM) band, for example, 915 MHz, 2.45 GHz, and/or 5.8 GHz.

The RF signal generation circuit 210 may include a voltage-controlled oscillator (VCO) that generates an RF signal having a different frequency depending on an input voltage. The RF signal generation circuit 210 may receive a control signal (e.g., a DC signal) from the processor 170 and generate an RF signal having a frequency corresponding to the received control signal. The processor 170 may store a control signal corresponding to a desired frequency in the form of a look-up table, or calculate a control signal corresponding to a desired frequency in real time through at least one operation.

In an example, the aerosol generating device 1 may further include a digital to analog converter (D/A converter) for converting a digital control signal output from the processor 170 into an analog control signal. The RF signal generation circuit 210 may receive the analog control signal and generate an RF signal having a frequency corresponding to the received analog control signal.

The drive amplifier 220 may amplify the RF signal generated by the RF signal generation circuit 210. For example, the drive amplifier 220 may provide an input signal suitable for a component of a next stage (e.g., the power amplifier 230) by amplifying the signal level (e.g., amplitude) of the RF signal. The drive amplifier 220 may minimize signal distortion by maintaining high linearity. However, since the drive amplifier 220 is an amplifier focused on increasing the signal level, the drive amplifier 220 may provide relatively low output power.

The power amplifier 230 may amplify power of an RF signal received from the drive amplifier 220. The power amplifier 230 may be an amplifier focused on providing sufficient power to a final output device (e.g., the radiating unit 30). For example, the power amplifier 230 may provide a high-power RF signal to the radiating unit 30 so that the radiating unit 30 may radiate electromagnetic waves into the insertion space to heat an aerosol-generating article. The power amplifier 230 may perform an amplification operation by using power received through the third power converter 160 that provides higher power and/or voltage than the second power converter 150.

The drive amplifier 220 and the power amplifier 230 may include transistors such as a bipolar junction transistor (BJT), a field effect transistor (FET), or a vacuum tube. In an example, the drive amplifier 220 and the power amplifier 230 may be, but are not limited to, gallium nitride (GaN) transistors configured to handle high efficiency, high speed, and high voltage. The drive amplifier 220 and the power amplifier 230 may also include an operational amplifier.

In FIG. 1, the drive amplifier 220 and the power amplifier 230 are illustrated as individual amplifiers, but the drive amplifier 220 and the power amplifier 230 may be integrated into a single amplifier. Additionally, the drive amplifier 220 and/or the power amplifier 230 may be configured as a series connection, a parallel connection, and/or a combination thereof of a plurality of amplifiers.

The radiating unit 30 may include at least one antenna for radiating electromagnetic waves into space. At least one antenna may have a size and shape suitable for the size and shape of an aerosol-generating article. For example, if the aerosol-generating article is cylindrical in shape, at least one antenna may be tubular surrounding the aerosol-generating article that is cylindrical. Here, the shape of the antenna being tubular may indicate that the overall shape of the antenna is tubular. In other words, if the antenna is formed of a metal (e.g., SUS) track, this may indicate that the overall shape of the entire track is tubular. The shape of at least one antenna is not limited to the examples described above and may include various shapes such as a flat plate shape, a curved plate shape, etc.

The radiating unit 30 may heat the aerosol-generating article by radiating electromagnetic waves (e.g., an amplified RF signal or a transmitted RF signal) into the insertion space. For the heating efficiency of the aerosol generating article to be maximized, resonance of electromagnetic waves is to occur within the insertion space. The resonance conditions (e.g., resonant frequency) of the insertion space may vary depending on the amount of dielectric contained in the inserted aerosol-generating article. The processor 170 may control the frequency of an RF signal generated by the RF signal generation circuit 210 to correspond to or be close to the resonance condition of the insertion space by adjusting a control signal input to the RF signal generation circuit 210. The processor 170 may use the directional coupler 240 to obtain information about the resonance conditions of the insertion space.

The directional coupler 240 may refer to a passive element having a waveguide structure that separates an incident wave and a reflected wave from each other. The directional coupler 240 may receive an RF signal transmitted from the power amplifier 230 toward the radiating unit 30 and electromagnetic waves reflected from the insertion space after they are radiated by the radiating unit 30. The directional coupler 240 may separate the transmitted RF signal and the reflected electromagnetic waves, and provide them to the processor 170.

In an example, the aerosol generating device 1 may further include an analog to digital converter (A/D converter) for converting an analog output of the directional coupler 240 into a digital output. The A/D converter may be built into the processor 170 or may exist as a separate component outside the processor 170. The processor 170 may analyze the characteristics (e.g., current, voltage, power, phase, and/or frequency) of the transmitted RF signal and the characteristics (e.g., current, voltage, power, phase, and/or frequency) of the reflected electromagnetic waves by monitoring the output of the directional coupler 240.

The processor 170 may determine whether the operation of the source unit 20 is being performed as intended, based on the characteristics of the transmitted RF signal. Additionally, the characteristics of the transmitted RF signal may be used to determine the heating efficiency of the source unit 20 or the radiating unit 30, together with the characteristics of the reflected electromagnetic wave. The processor 170 may control the source unit 20 such that the heating efficiency of the source unit 20 or the radiating unit 30 is maximized. For example, the processor 170 may adjust the frequency of an RF signal generated by the RF signal generation circuit 210 such that the power of the reflected electromagnetic waves is minimized. Minimizing the power of the reflected electromagnetic waves may indicate that the frequency of the RF signal is closer to the resonance conditions of the insertion space. The characteristics of the transmitted RF signal may provide a criterion for whether the power of the reflected electromagnetic waves is minimized.

Since resonance of electromagnetic waves may occur in the insertion space depending on the frequency of the RF signal, the insertion space may be referred to as a resonant section. At least a portion of the insertion space may be surrounded by at least one shielding member to prevent electromagnetic waves from leaking outside the aerosol generating device 1. In an embodiment, the insertion space may further include a physical structure to ensure that the resonance conditions are within a range controllable by the processor 170. The physical structure may include at least one conductor, and the resonance conditions of the insertion space may vary depending on the arrangement, thickness, and length of the conductor. Additionally, the physical structure may include a space for accommodating a dielectric having low electromagnetic absorption, separate from the dielectric contained in the aerosol-generating article. A dielectric with low electromagnetic absorption may change the resonant frequency of the entire resonant section without absorbing the energy that are to be transferred to the heated material. Accordingly, even if the resonant section is reduced in size, the resonance conditions may be determined within a range controllable by the processor 170.

The temperature sensing circuit 250 may be arranged in contact with or adjacent to components included in the source unit 20 to measure the temperature of the source unit 20. For example, the temperature sensing circuit 250 may be arranged in contact with or adjacent to at least one of the RF signal generation circuit 210, the drive amplifier 220, and the power amplifier 230. Heat may be generated due to limited efficiency in the process of generating and/or amplifying RF signals, and if excessive heat is generated, this heat may have a negative impact on components included in the source unit 20 or other components included in the aerosol generating device 1. The temperature measured by the temperature sensing circuit 250 may be used to prevent overheating of the source unit 20.

The processor 170 may receive the temperature (or a value corresponding to the temperature) measured from the temperature sensing circuit 250, and if it is determined that the source unit 20 is overheated, the processor 70 may stop the operation of the source unit 20. For example, the processor 170 may stop the operation of the source unit 20 by cutting off the power supply to the source unit 20 or transmitting a control signal. Hereinafter, the term ‘power supply’ to the source unit 20 is used to indicate controlling whether the source unit 20 operates.

The temperature sensing circuit 250 may include at least one temperature sensor among a thermocouple, a resistance temperature detector (RTD), a thermistor, a semiconductor temperature sensor, and an optical temperature sensor. In an example, the temperature sensing circuit 250 may be implemented as a chip-type sensor (e.g., a negative temperature coefficient (NTC) sensor) to minimize the area occupied, but is not limited thereto.

The aerosol generating device 1 may include other components in addition to the components illustrated in FIG. 1. For example, the aerosol generating device 1 may further include a sensor unit, an output unit, an input unit, a communication unit, and a memory. In addition, if the aerosol generating device 1 is a hybrid type device that uses both an aerosol-generating article and a cartridge, the aerosol generating device 1 may further include a cartridge heater. The cartridge heater may receive power from the power supply 130 to heat a medium and/or an aerosol-generating material within the cartridge.

According to an embodiment, the sensor unit may detect the status of the aerosol generating device 1 or the status around the aerosol generating device 1 and transmit the detected information to the processor 170. For example, the sensor unit may include a temperature sensor, a puff sensor, an insertion detection sensor, a reuse detection sensor, an overly moist detection sensor, a cigarette identification sensor, a cartridge detection sensor, a cap detection sensor, and/or a motion detection sensor. The sensor unit may further include various sensors, such as a liquid remaining amount sensor for detecting the remaining liquid amount of the cartridge, and an immersion sensor for detecting immersion of the aerosol generating device 1.

In an embodiment, the temperature sensor may detect the temperature of the insertion space or the aerosol-generating article. The temperature sensor may be positioned in contact with or adjacent to the insertion space or the aerosol-generating article to directly measure the temperature of the insertion space or the aerosol-generating article. Additionally, the temperature sensor may be positioned to be spaced apart from the insertion space or the aerosol-generating article to indirectly measure the temperature of the insertion space or the aerosol-generating article (e.g., in a non-contact manner). In an example, the temperature sensor may include an optical temperature sensor (e.g., an infrared temperature sensor).

In an embodiment, the temperature sensor may detect the temperature of the power supply 130. The temperature sensor may be arranged adjacent to the power supply 130. For example, the temperature sensor may be attached to one surface of the power supply 130 (e.g., a battery) and/or mounted on one surface of a printed circuit board. For example, the aerosol generating device 1 may include a protection circuit module (PCM), and the temperature sensor may be positioned adjacent to the power supply 130 together with the PCM.

According to an embodiment, the temperature sensor may be arranged inside the housing (not shown) of the aerosol generating device 1 to detect the temperature inside the housing (not shown).

In an embodiment, the puff sensor may detect a user's puff.

As an example, the puff sensor may include a pressure sensor. The pressure sensor may output a signal corresponding to the internal pressure of the aerosol generating device 1, and the processor 170 may detect a user's puff based on the signal corresponding to the internal pressure. The internal pressure of the aerosol generating device 1 may correspond to pressure of an airflow path on which gas flows. The puff sensor may be disposed to correspond to the airflow path, through which gas flows, in the aerosol generating device 1.

In another example, the puff sensor may include a temperature sensor. When a user puffs, a temporary temperature drop may occur in the airflow path, the insertion space, the aerosol generating article, etc. The processor 170 may detect the user's puff based on a signal corresponding to the temperature of an airflow path, etc. output from a temperature sensor.

In another example, the puff sensor may include both a pressure sensor and a temperature sensor. In this case, the temperature sensor may measure the temperature which is used to correct the internal pressure measured by the pressure sensor. For example, the puff sensor may correct a signal corresponding to internal pressure based on a temperature measured by the temperature sensor and output the corrected signal. In another example, the puff sensor may output a signal corresponding to a temperature measured by the temperature sensor and a signal corresponding to the internal pressure measured by the puff sensor. In this case, the processor 170 may receive the signals and correct the signal corresponding to the internal pressure, based on the signal corresponding to the temperature.

In another example, the puff sensor may include a capacitance-based sensor. In the disclosure, the capacitance-based sensor may also be referred to as a capacitive sensor. When a user puffs, temperature changes and/or aerosol flow may occur within the insertion space, thereby changing the permittivity within the insertion space. The processor 170 may detect the user's puff based on a signal corresponding to the permittivity inside the insertion space output from the capacitive sensor.

The puff sensor is not limited to the examples described above and may be implemented with various sensors to detect the user's puff.

In an embodiment, the insertion detection sensor may detect insertion and/or removal of an aerosol-generating article. The insertion detection sensor may be installed around the insertion space.

As an example, the insertion detection sensor may include a capacitive sensor. The capacitive sensor may include at least one conductor, wherein the at least one conductor may be positioned adjacent to the insertion space. When an aerosol generating article is inserted or removed within the insertion space, the permittivity around the conductor may change. The processor 170 may detect insertion and/or removal of an aerosol-generating article based on a signal corresponding to the permittivity inside the insertion space output from the capacitive sensor.

In another example, the insertion detection sensor may include an inductive sensor. The inductive sensor may include at least one coil, wherein the at least one coil may be positioned adjacent to the insertion space. When an aerosol-generating article (e.g., a wrapper for the aerosol-generating article) contains a conductor, a change in the magnetic field may occur around the current-carrying coil when the aerosol-generating article is inserted into or removed from the insertion space. The processor 170 may detect insertion and/or removal of an aerosol-generating article including a conductor based on characteristics of a current output from or detected by an inductive sensor (e.g., frequency of an alternating current, current value, voltage value, inductance value, impedance value, etc.). Alternatively, the aerosol-generating article (e.g., the medium portion of the aerosol-generating article) may include a susceptor (e.g., SUS). Even in this case, a change in the magnetic field around the coil may occur based on the insertion or removal of a susceptor or the like within the insertion space, and the processor 170 may also detect the insertion and/or removal of the aerosol-generating article based on the characteristics of the current of the inductive sensor.

The insertion detection sensor is not limited to the examples described above and may be implemented using various sensors (e.g., proximity sensors, etc.) for detecting insertion and/or removal of an aerosol-generating article. Additionally, the insertion detection sensor may include any combination of the examples described above. In an embodiment, the insertion detection sensor may include a switch or the like for detecting compression by an aerosol-generating article.

In an embodiment, the reuse detection sensor may detect whether an aerosol-generating article has been reused. As an example, the reuse detection sensor may be a color sensor for detecting the color of the aerosol generating article. When the aerosol-generating article is used by a user, a change in color of a portion of the wrapper surrounding the outside of the aerosol-generating article may occur due to the generated aerosol or heating. The color sensor may output a signal corresponding to optical characteristics (e.g., wavelength of light) corresponding to the color of the wrapper based on light reflected from the wrapper. The processor 170 may determine that the aerosol-generating article inserted into the insertion space has already been used if a change in color of a portion of the wrapper is detected.

In an embodiment, the overly moist detection sensor may detect whether the aerosol-generating article is overly moist. For example, the overly moist detection sensor may include a capacitive sensor. The capacitive sensor may include at least one conductor positioned adjacent to the insertion space. The processor 170 may detect whether the aerosol-generating article is overly moist, based on the level of a signal corresponding to a permittivity or the like output from the capacitive sensor. For example, the processor 170 may determine a level range within which the level of the signal is included, based on a look-up table, and determine the moisture content of the aerosol-generating article based on the determined level range.

In an embodiment, the cigarette identification sensor may detect whether the aerosol-generating article is authentic and/or detect the type of the aerosol-generating article.

As an example, the cigarette identification sensor may include an optical sensor for detecting an identification material (or identification tag) located on an outer surface of an aerosol-generating article (e.g., a wrapper). The optical sensor may irradiate light toward the identification material (or identification mark) of the aerosol-generating article and detect, based on the reflected light, the authenticity and/or type of the aerosol-generating article. For example, the identification material may include a material that emits light of a particular wavelength, based on the irradiated light. The processor 170 may detect whether the aerosol-generating article is authentic and/or the type of the article based on the range of the wavelength.

In another example, the cigarette identification sensor may include a capacitive sensor. Depending on the type of aerosol generating article inserted into the insertion space, the permittivity inside the insertion space may vary. The processor 170 may detect whether the aerosol generating article is authentic and/or the type thereof based on a signal corresponding to the permittivity inside the insertion space output from the capacitive sensor.

In another example, the cigarette identification sensor may include an inductive sensor. When a conductor is included in a wrapper and/or interior (e.g., medium portion) of an aerosol-generating article inserted into the insertion space, the characteristics of the current detected by the inductive sensor (e.g., frequency of AC current, current value, voltage value, inductance value, impedance value, etc.) may differ depending on the type of the aerosol-generating article inserted into the insertion space. The processor 170 may detect whether the inserted aerosol-generating article is authentic and/or the type thereof based on the characteristics of the current output from or detected by the inductive sensor.

The cigarette identification sensor is not limited to the examples described above and may be implemented using various sensors to detect whether the aerosol-generating article is authentic and/or to detect the type of the aerosol-generating article. Additionally, the cigarette identification sensor may include any combination of the examples described above.

In an embodiment, the cartridge detection sensor may detect mounting and/or removal of a cartridge. For example, the cartridge detection sensor may include an inductive sensor, a capacitive sensor, a resistive sensor, a hall sensor (hall IC) and/or an optical sensor.

In an embodiment, the cap detection sensor may detect attachment and/or removal of a cap. For example, the cap detection sensor may include an inductive sensor, a capacitive sensor, a resistive sensor, a contact sensor, a hall sensor (hall IC) and/or an optical sensor. The cap may include a structure that covers at least a portion of a cartridge mounted or inserted into the aerosol generating device 1, or covers at least a portion of the housing of the aerosol generating device 1. The cap detection sensor may output a signal corresponding to the mounting or removal of the cap when the cap is mounted on or removed from the housing, and the processor 170 may detect the mounting or removal of the cap based on the signal corresponding to the mounting or removal.

According to an embodiment, the motion detection sensor may detect movement of the aerosol generating device 1. The motion detection sensor may be implemented using at least one of an acceleration sensor or a gyro sensor.

According to an embodiment, the sensor unit may further include, in addition to the sensors described above, at least one of a humidity sensor, an atmospheric pressure sensor, a magnetic sensor, a position sensor (global positioning system (GPS)), or a proximity sensor. The functions of the sensors would be instinctively understood by one of ordinary skill in the art in view of their names and thus detailed descriptions thereof are omitted herein.

According to an embodiment, the output unit may output information about the status of the aerosol generating device 1. The output unit may include, but is not limited to, a display, a haptic unit, and/or an audio output unit. For example, information about the aerosol generating device 1 may include the charging/discharging status of the power supply 130 of the aerosol generating device 1, the operating status of the source unit 20 or the radiating unit 30, the insertion/removal status of the aerosol-generating article and/or cartridge, the mounting and/or removal status of the cap, or the status in which the use of the aerosol generating device 1 is limited (e.g., detection of an abnormal article). The display may visually provide information to the user about the status of the aerosol generating device 1. For example, the display may include a light-emitting diode (LED) light emitting element, a liquid crystal display (LCD) panel, an organic light-emitting diode (OLED) display panel, etc. The display, if the display includes a touchpad, may also be used as an input device. The haptic unit may provide tactile information to the user about the status of the aerosol generating device 1. For example, the haptic component may include a vibration motor, a piezoelectric element, an electrical stimulation device, and the like. The audio output unit may provide information about the aerosol generating device 1 to the user audibly. For example, the audio output unit may convert an electrical signal into an audio signal and output the same externally.

According to an embodiment, the input unit may receive information input from a user. For example, the input unit may include a touch panel, a button, a key pad, a dome switch, a jog wheel, a jog switch, and the like.

According to an embodiment, the memory may be hardware that stores various data processed within the aerosol generating device 1, and may store data processed by the processor 170 and data to be processed. For example, the memory may include at least one type of storage medium among a flash memory type, a hard disk type, a multimedia card micro type, a card type memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. For example, the memory may store data about the operation time of the aerosol generating device 1, the maximum number of puffs, the current number of puffs, at least one temperature profile, and the user's smoking pattern.

According to an embodiment, the communication unit may include at least one component for communicating with another electronic device (e.g., a portable electronic device). For example, the communication unit may include a Bluetooth communication unit, a Bluetooth Low Energy (BLE) communication unit, a near field Communication unit, a wireless local area network (WLAN) communication unit, a Zigbee communication unit, an infrared (Infrared Data Association (IrDA)) communication unit, a wireless fidelity direct (WFD) communication unit, a ultra-wideband (UWB) communication unit, an Adaptive Network Topology (ANT)+communication unit, a cellular network communication unit, an Internet communication unit, a computer network (e.g., LAN or WAN) communication unit, etc.

According to an embodiment, the processor 170 may control the temperature of the insertion space or the aerosol-generating article by controlling an amplification factor of the source unit 20 (e.g., the power amplifier 230). The processor 170 may control the amplification factor of the source unit 20 (e.g., the power amplifier 230) based on the temperature of the insertion space or the aerosol-generating article detected using the temperature sensor. The processor 170 may control the amplification factor of the source unit 20 (e.g., the power amplifier 230) based on the temperature profile and/or power profile stored in the memory.

Additionally, the processor 170 may control the temperature of the cartridge heater by controlling the supply of power from the power supply 130 to the cartridge heater. The processor 170 may control the temperature of the cartridge heater and/or power supplied to the cartridge heater, based on the temperature of the cartridge heater detected using the temperature sensor. The processor 170 may control the temperature of the cartridge heater and/or the power supplied to the cartridge heater based on the temperature profile and/or power profile stored in the memory.

In an embodiment, the processor 170 may prevent the insertion space, the aerosol-generating article, and/or the cartridge heater from overheating. For example, the processor 170 may control the operation of the power conversion circuit to reduce the amount of power supplied to the source unit 20 or the cartridge heater, or to stop supplying power to the source unit 20 or the cartridge heater, based on a determination that temperature of the insertion space, the aerosol-generating article, and/or the cartridge heater exceeds a preset threshold temperature.

According to an embodiment, the processor 170 may control power supply to the source unit 20 or the cartridge heater, based on a result detected by the sensor unit.

In an embodiment, the processor 170 may control power supply to the source unit 20 or the cartridge heater based on insertion and/or removal of the aerosol-generating article into the insertion space. For example, the processor 170 may control power to be supplied to the source unit 20 or the cartridge heater when it is determined that the aerosol-generating article has been inserted into the insertion space using the insertion detection sensor. The processor 170 may cut off the power supply to the source unit 20 or the cartridge heater if it is determined that the aerosol-generating article has been removed from the insertion space using the insertion detection sensor. The processor 170 may determine that the aerosol-generating article has been removed from the insertion space, if the temperature of the insertion space or the aerosol-generating article is above a limited temperature or if the temperature change gradient of the insertion space or the aerosol-generating article is equal to or above a set gradient.

In an embodiment, the processor 170 may control the power supply time and/or power supply amount of power supplied to the source unit 20 or the cartridge heater, based on the state of the aerosol-generating article. For example, the processor 170 may increase the power supply time (e.g., preheating time) of power supply to the source unit 20 or the cartridge heater, if it is determined that the aerosol-generating article is in an overly moist state by using the overly moist detection sensor.

In an embodiment, the processor 170 may control power supply to the source unit 20 or the cartridge heater based on whether the aerosol-generating article is to be reused. For example, the processor 170 may cut off power supply to the source unit 20 or the cartridge heater if it is determined that the aerosol-generating article has been used.

In an embodiment, the processor 170 may control power supply to the source unit 20 or the cartridge heater, based on whether the cartridge is engaged and/or removed. For example, the processor 170 may stop supplying power to the source unit 20 or the cartridge heater or control power not to be supplied to the source unit 20 or the cartridge heater if it is determined, by using the cartridge detection sensor, that the cartridge is removed.

In an embodiment, the processor 170 may control power supply to the source unit 20 or the cartridge heater based on whether the aerosol-generating material in the cartridge has been exhausted. For example, the processor 170 may determine that the aerosol-generating material in the cartridge is exhausted if it is determined that the temperature of the cartridge heater exceeds a limit temperature while preheating the cartridge heater (i.e., during the preheating period). If it is determined that the aerosol-generating material in the cartridge has been exhausted, the processor 170 may cut off the supply of power to the source unit 20 or the cartridge heater.

In an embodiment, the processor 170 may control power supply to the source unit 20 or the cartridge heater based on the availability of the cartridge. For example, the processor 170 may determine that the cartridge is no longer usable if it is determined that the current number of puffs is equal to or greater than the maximum number of puffs set for the cartridge based on data stored in the memory. Alternatively, the processor 170 may determine that the cartridge is unusable if the total time that the cartridge heater has been heated is equal to or greater than a preset maximum time or the total amount of power supplied to the cartridge heater is equal to or greater than a preset maximum amount of power. In this case, the processor 170 may stop supplying power to the source unit 20 or the cartridge heater or control power not to be supplied to the source unit 20 or the cartridge heater.

In an embodiment, the processor 170 may control power supply to the source unit 20 or the cartridge heater based on the user's puff. For example, the processor 170 may use a puff sensor to determine whether a puff has occurred and/or the intensity of the puff. The processor 170 may cut off the power supply to the source unit 20 or the cartridge heater if the number of puffs reaches a preset maximum number of puffs and/or if no puffs are detected for a preset period of time. The processor 170 may also control the supply of power to the source unit 20 or the cartridge heater when a puff is detected.

In an embodiment, the processor 170 may control power supply to the source unit 20 or the cartridge heater based on the authenticity and/or type of the aerosol-generating article (or the cartridge). For example, the processor 170 may use the cigarette identification sensor to detect the authenticity and/or type of the aerosol-generating article (or the cartridge). For example, the processor 170 may cut off power supply to the source unit 20 or the cartridge heater if the aerosol-generating article (or the cartridge) is detected to be counterfeit. The processor 170 may control (e.g., initiate) the supply of power to the source unit 20 or the cartridge heater when the aerosol-generating article (or the cartridge) is detected to be authentic. In another example, the processor 170 may control power supply to the source unit 20 or the cartridge heater differently depending on the type of the aerosol-generating article (or the cartridge). The processor 170 may control the amplification factor of the source unit 20 or the temperature and/or power of the cartridge heater, based on a first temperature profile (or a first power profile) when the aerosol-generating article (or the cartridge) is detected to be a first aerosol-generating article (or a first cartridge), and may control the amplification factor of the source unit 20 or the temperature and/or power of the cartridge heater, based on a second temperature profile (or a second power profile) when the aerosol-generating article (or the cartridge) is detected to be a second aerosol-generating article (or a second cartridge).

According to an embodiment, the processor 170 may control the output unit based on a result detected by the sensor unit. For example, the processor 170 may control the output unit to provide visual, tactile and/or auditory information indicating that the aerosol generating device 1 is about to be terminated, when the number of puffs counted using the puff sensor reaches a preset number. For example, the processor 170 may control the output unit to provide visual, tactile and/or auditory information about the temperature of the insertion space, the aerosol-generating article, or the cartridge heater.

According to an embodiment, the processor 170 may store and update a history of events that occurred in the memory based on the occurrence of a given event. For example, the event may include operations such as detection of insertion of an aerosol-generating article, initiation of heating of an aerosol-generating article, detection of a puff, termination of a puff, detection of overheating, detection of overvoltage application to a cartridge heater, termination of heating of an aerosol-generating article, turning on/off power of the aerosol generating device 1, initiation of charging of the power supply 130, detection of overcharge of the power supply 130, termination of charging of the power supply 130, etc., performed in the aerosol generating device 1. For example, the history of events may include the time an event occurred, log data corresponding to the event, etc. For example, if a given event is detection of insertion of an aerosol-generating article, log data corresponding to the event may include data about sensing values of an insertion detection sensor, etc. For example, if a given event is overheating detection of a cartridge heater, log data corresponding to the event may include data about a temperature of the cartridge heater, a voltage applied to the cartridge heater, a current flowing through the cartridge heater, etc.

According to an embodiment, the processor 170 may control the communication unit to form a communication link with an external device, such as a user's mobile terminal.

According to an embodiment, the processor 170 may release a restriction on the use of at least one function (e.g., a heating function) of the aerosol generating device 1 when data regarding authentication is received from an external device via a communications link. For example, data regarding authentication may include the user's date of birth, a unique number that identifies the user, whether the user has completed authentication, etc.

According to an embodiment, the processor 170 may transmit data about the status of the aerosol generating device 1 to an external device via a communication link (e.g., remaining capacity of the power supply 130, operating mode, etc.). The transmitted data may be output through a display of an external device, etc.

According to an embodiment, when a request for location search of the aerosol generating device 1 is received from an external device via a communication link, the processor 170 may control the output unit to perform an operation corresponding to the location search. For example, the processor 170 may control the haptic unit to generate vibration or control the display to output an object corresponding to the location search and search termination.

According to an embodiment, the processor 170 may perform a firmware update when firmware data is received from an external device via a communication link.

According to an embodiment, the processor 170 may transmit data on sensed values of at least one sensor unit to an external server (not shown) via a communication link, and receive and store a learning model generated by learning the sensed values through machine learning, such as deep learning, from the server. The processor 170 may perform operations such as determining a user's inhalation pattern and generating a temperature profile using a learning model received from a server.

Although not illustrated in FIG. 1, the aerosol generating device 1 may further include a power protection circuit. The power protection circuit may include at least one switching element and may cut off the current path to the power supply 130 in response to overcharge and/or overdischarge of the power supply 130.

An aerosol-generating article as described herein may include at least one aerosol-generating rod (e.g., a medium portion) and at least one filter rod. The radiating unit 30 may be arranged to correspond to at least one aerosol-generating rod, and may be designed differently depending on the arrangement order and/or position of the aerosol-generating rod and the filter rod. The aerosol-generating rod may include at least one of nicotine, an aerosol-generating material, and an additive. For example, the aerosol-generating material may include glycerin (e.g., vegetable glycerin (VG)) and/or propylene glycol (PG), and may also include various other materials. For example, the additive may include flavoring agents and/or organic acids, and may also include various other substances. For example, the aerosol-generating rod may include an aerosol-generating substrate (e.g., a sheet) impregnated with a liquid non-tobacco material (e.g., an aerosol-generating material and/or nicotine), and/or may include a solid tobacco material (e.g., leaf tobacco, reconstituted tobacco, etc.). The tobacco material may be included in the aerosol-generating rod in various forms, such as cut tobacco, granules, or powder. In an embodiment, the additive of the aerosol-generating rod may include a basic substance. Based on the basic material, the nicotine of the tobacco material included in the aerosol-generating rod may have an alkaline pH (e.g., pH 7.0 or higher). In this case, freebase nicotine may be released from the aerosol-generating rod even at low temperatures. According to an embodiment, the aerosol-generating rod may include two or more aerosol-generating rods, wherein the two or more aerosol-generating rods may each include tobacco material and/or non-tobacco material. Although not shown, at least one aerosol-generating rod and at least one filter rod may be individually and/or integrally wrapped by at least one wrapper. In the disclosure, the aerosol-generating article may be referred to as a stick.

The cartridge referred to in the disclosure may include an aerosol-generating material having any one of a liquid state, a solid state, a gaseous state, or a gel state therein. The aerosol-generating material may include a liquid composition. For example, the liquid composition may be a liquid including a tobacco-containing material including a volatile tobacco flavor component, or may be a liquid including a non-tobacco material. The cartridge may include a storage portion containing an aerosol-generating material and/or a liquid transfer means impregnated with (containing) the aerosol-generating material. For example, the liquid transfer medium may include a wick such as cotton fibers, ceramic fibers, glass fibers, porous ceramics, etc. The cartridge heater may be included in the cartridge in the form of a coil surrounding (or winding) the liquid transfer means or in a structure contacting one side of the liquid transfer means. Alternatively, the cartridge heater may be included in the aerosol generating device 1 that is separable from the cartridge.

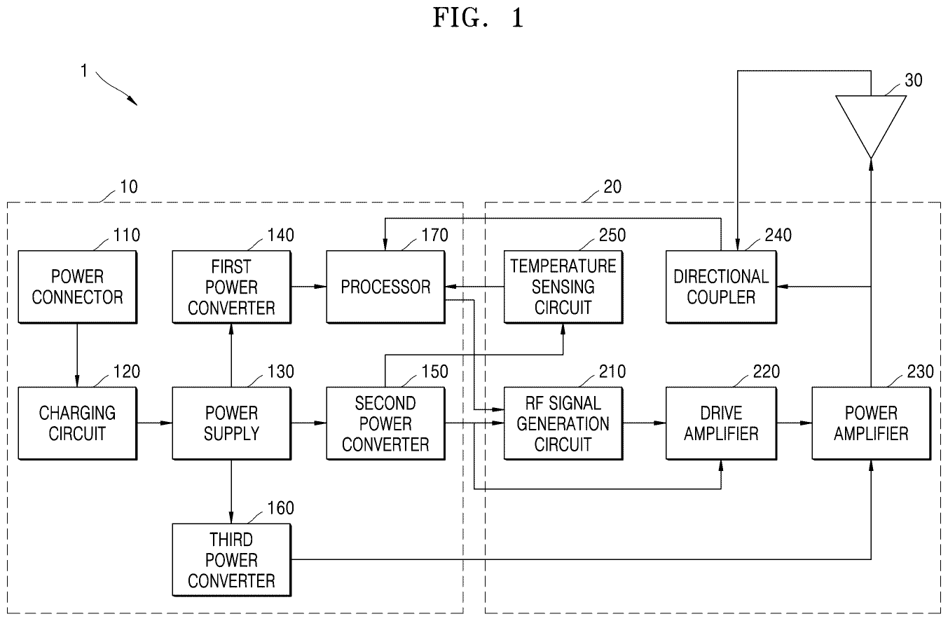

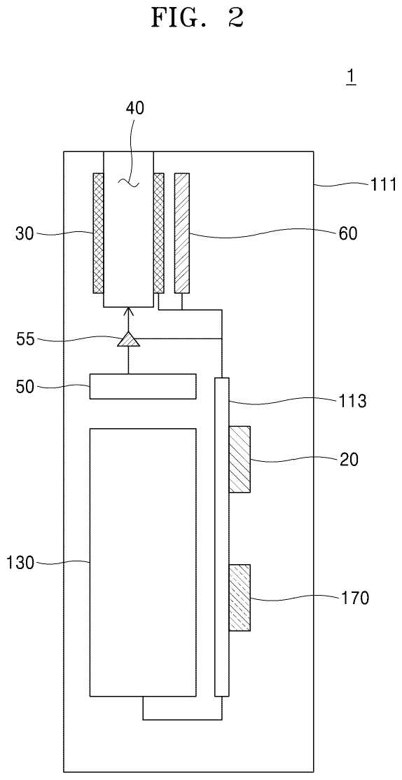

FIG. 2 is a cross-sectional view of an aerosol generating device according to an embodiment.

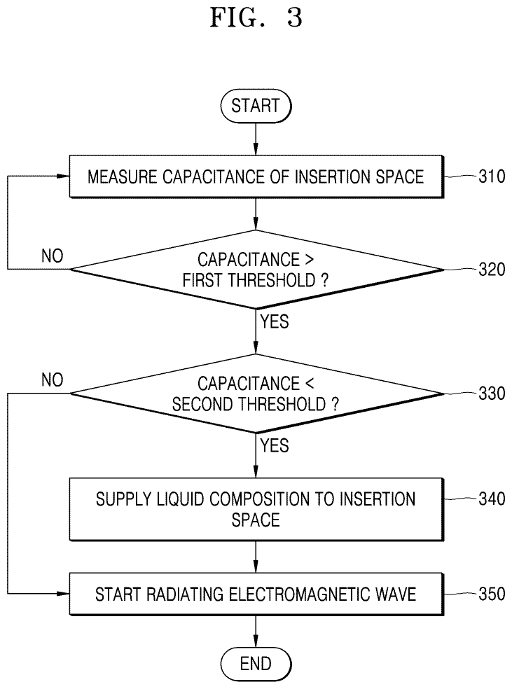

An aerosol generating device 1 according to an embodiment (for example, the aerosol generating device 1 of FIG. 1) may include a housing 111, a circuit board 113, a source unit 20, a radiation unit 30, a liquid reservoir 50, a pump 55, a capacitive sensor 60, a power supply 130 (for example, the power supply 130 of FIG. 1), and a processor 170. However, only the components necessary for describing the present embodiment are illustrated in FIGS. 2 and 3, but components of the aerosol generating device 1 are not limited thereto. Depending on the embodiments, some of the illustrated components may be omitted or new components may be added thereto.

The housing 111 may include an insertion space 40 for accommodating or inserting at least a part of an aerosol generating article, and may form the overall appearance of the aerosol generating device 1. Components of the aerosol generating device 1 may be arranged in an internal space of the housing 111.

For example, the circuit board 113, the radiation unit 30, the liquid reservoir 50, the pump 55, the capacitive sensor 60, and the power supply 130 may be arranged in the internal space of the housing 111. However, components of the aerosol generating device 1 arranged in the internal space of the housing 111 are not limited thereto.

The circuit board 113 may be a circuit board for generating an RF (radio frequency) signal. The source unit 20 and the processor 170 may be mounted on the circuit board 113. Therefore, the circuit board 113 may generate an RF signal when receiving power. However, a circuit included in the circuit board 113 is not limited thereto.

The radiation unit 30 may radiate the RF signal generated by the source unit 20 in the form of an electromagnetic wave toward an aerosol generating article inserted in the insertion space 40. The radiation unit 30 is electrically or operatively connected to the circuit board 113 and may radiate electromagnetic waves (for example, microwaves) toward the insertion space 40 in response to the RF signal supplied from the source unit 20. For example, the radiation unit 30 may surround an outer circumference of the insertion space 40 and radiate electromagnetic waves toward an aerosol generating article inserted in the insertion space 40.

The radiated electromagnetic waves may cause the charges or ions in a dielectric (for example, glycerin) included in an aerosol generating article to vibrate or rotate, and accordingly, frictional heat may be generated from the dielectric to heat the aerosol generating article. Therefore, an aerosol is generated. For example, as an aerosol generating article is heated, vapor is generated and mixed with external air flowing into the insertion space 40 through a gap between the insertion space 40 and the aerosol generating article or an airflow passage (not illustrated), and accordingly, an aerosol may be generated.

The capacitive sensor 60 may include at least one conductor, and at least one conductor may be arranged adjacent to the insertion space 40. The processor 170 may measure internal capacitance of the insertion space 40 based on a sensed value corresponding to permittivity or so on output from the capacitive sensor 60. When an aerosol generating article is inserted into or removed from the insertion space 40, the permittivity around the conductor may vary. The processor 170 may determine whether an aerosol generating article is inserted in the insertion space 40, in response to a signal which is output from the capacitive sensor 60 and corresponds to the permittivity or so on of the insertion space 40.

The liquid reservoir 50 may include a liquid composition. The liquid composition may include water. The liquid composition may be a liquid including a tobacco-containing material including a volatile tobacco flavor component, or may be a liquid including a non-tobacco material. The liquid composition may include polar molecules that is sensitive to dielectric heating. The liquid composition may have a relatively high permittivity compared to air. The liquid reservoir 50 may be connected to a liquid conduit (not illustrated) extending to the insertion space 40. The liquid composition may be supplied to the insertion space 40 through the liquid conduit.

The pump 55 may supply the liquid composition from the liquid reservoir 50 into the insertion space 40 at a controlled rate. The pump 55 may include a stepper motor, a syringe pump, and a peristaltic pump in combination with an osmotic pump or a piezoelectric pump. The pump 55 may be electrically connected to the circuit board 113 to be controlled by the processor 170.

The processor 170 may control an operation of the pump 55 such that a resonance frequency of the insertion space 40 is maintained within an allowable range of a target resonance frequency.

The resonance frequency of the insertion space 40 may be varied by various factors. Factors that primarily affect the resonance frequency of the insertion space 40 may include a structure (for example, a size or radius of the insertion space 40, a material of the insertion space 40, and so on) of the space (40) and the permittivity of the insertion space 40. The structure of the insertion space 40 may have a fixed value, but the permittivity of the insertion space 40 may vary. For example, depending on the type of an aerosol generating article inserted into the insertion space 40, the amount of dielectric included in the aerosol generating article may change, and accordingly, the permittivity of the insertion space 40 may vary. Also, when an aerosol generating article is heated by microwaves, the permittivity of the insertion space 40 may vary as the dielectric is consumed.

In order to satisfy a resonance condition of the insertion space 40, the frequency of an electromagnetic wave radiated to an aerosol generating article has to be continuously adjusted. However, when adjusting the frequency, impedance matching between the source unit 20 for generating an RF signal and the radiation unit 30 for radiating electromagnetic waves may not be done due to a change in frequency. When the impedance matching is not done, a reflection loss between the source unit 20 for generating an RF signal and the radiation unit 30 for radiating electromagnetic waves increases, and the heating efficiency of an aerosol generating article decreases. That is, considering the decrease in heating efficiency of an aerosol generating article, there is a limit to adjusting a frequency of the electromagnetic wave radiated to the aerosol generating article to satisfy a resonance condition.

A target resonance frequency may be preset as a target value of a resonance frequency of the insertion space 40. The target resonance frequency may be preset by considering factors, such as a size or radius of the insertion space 40, an average temperature of the insertion space 40, and average permittivity of an aerosol generating material used for the aerosol generation device 1. The source unit 20 for generating an RF signal, and the radiation unit 30 for radiating electromagnetic waves may be designed to cause impedance to match at a target resonance frequency. As a result, the aerosol generation device 1 may obtain maximum heating efficiency when a resonance frequency of the insertion space 40 is close to the target resonance frequency.

The processor 170 may control an operation of the pump 55 while the aerosol generation device 1 is in operation such that the permittivity of the insertion space 40 is maintained in a certain range. As a result, the resonance frequency of the insertion space 40 may be maintained in an allowable range of the target resonance frequency while the aerosol generating device 1 is in operation. As a result, the aerosol generating device 1 according to an embodiment may satisfy a resonance condition of the insertion space 40 without varying a frequency of the electromagnetic wave radiated to an aerosol generating article, and accordingly, impedance matching between the source unit 20 for generating the RF signal and the radiation unit 30 for radiating electromagnetic waves may be maintained, and heating efficiency may be maintained at a maximum level.

The processor 170 may control an operation of the pump 55 based on a sensed value of the capacitive sensor 60. The processor 170 may preset a target value of capacitance to correspond to a target resonance frequency and set a target capacitance range having a preset range of the target value of the capacitance. The target capacitance range may have a lower limit and an upper limit of the target value of the capacitance. The processor 170 may control an operation of the pump 55 when a capacitance value of the insertion space 40 is less than the lower limit of the target capacitance range.

The processor 170 may stop the operation of the pump 55 when the capacitance value of the insertion space 40 is greater than the upper limit of the target range.

In another embodiment, the processor 170 may control the operation of the pump 55 based on the information input to an input unit (not illustrated). For example, a user may supply a liquid composition to the insertion space 40 through the input unit, and may also control the amount of liquid composition supplied to the insertion space 40. When the liquid composition is supplied to the insertion space 40, the amount of vaporization may be increased, and the amount of transferred nicotine may be increased. As a result, by controlling an operation of the pump 55 through the input unit, a user may experience a variety of smoking according to preference of the user. An output unit (not illustrated) may output information on an operation of the pump 55. The processor 170 may generate information on the amount of vaporization, taste, or aroma of an aerosol inhaled by a user in response to an operation of the pump 55 and transmit the information to the output unit.

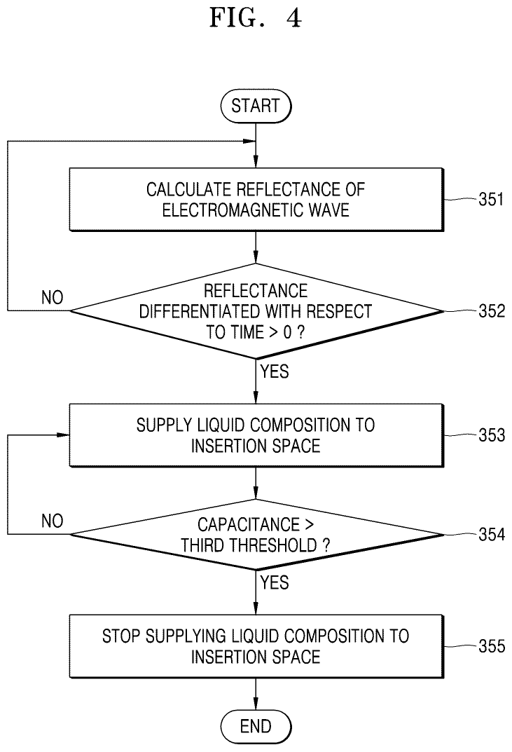

Hereinafter, a method of controlling an operation of an aerosol generating device is described in detail with reference to FIGS. 3 and 4.

FIG. 3 is a flowchart illustrating a method of controlling an operation of an aerosol generating device according to an embodiment.

Referring to FIGS. 1 to 3, in operation 310, the processor 170 may measure capacitance of the insertion space 40 based on a sensed value corresponding to permittivity and so on output from the capacitive sensor 60.

In operation 320, the processor 170 may determine whether an aerosol generating article is inserted in the insertion space 40 based on a signal corresponding to permittivity and so on of the insertion space 40 which is output from the capacitive sensor 60. Specifically, the processor 170 may determine that an aerosol generating article is inserted in the insertion space 40 when the capacitance of the insertion space 40 exceeds a first threshold.

In operation 330, the processor 170 may control an operation of the pump 55 based on a sensed value of the capacitive sensor 60.

Specifically, when the capacitance of the insertion space 40 is less than a second threshold, the processor 170 may operate the pump 55 to supply a liquid composition to the insertion space 40 (operation 340). The second threshold is the lower limit of the target capacitance range described above.

In operation 340, the processor 170 may preset the amount of liquid composition supplied to the insertion space 40. The amount of liquid composition supplied to the insertion space 40 may be preset by totally considering permittivity of the liquid composition included in the liquid reservoir 50, and a difference between a capacitance value of the insertion space 40 and the lower limit of the target capacitance range. For example, the processor 170 may control the operation of the pump 55 such that the amount of liquid composition supplied to the insertion space 40 is proportional to the difference between the capacitance value of the insertion space 40 and the lower limit of the target capacitance range. The processor 170 may maintain the permittivity of the insertion space 40 in a certain range by controlling the operation of the pump 55 while the aerosol generating device is in operation. As a result, while the aerosol generating device is in operation, a resonance frequency of the insertion space 40 may be maintained in an allowable range of a target resonance frequency.

In operation 350, the processor 170 may control the source unit 20 such that the radiation unit 30 radiates electromagnetic waves into the insertion space 40. Specifically, the processor 170 may cause the source unit 20 to transmit an RF signal toward the radiation unit 30. The processor 170 may control the intensity or frequency of an RF signal output by the source unit 20 based on a temperature profile and/or power profile stored in a memory.

FIG. 4 is a flowchart illustrating a method of controlling an operation of an aerosol generating device, according to another embodiment.

FIG. 4 specifically illustrates operation 350 of FIG. 3 and illustrates a method of controlling an operation of the pump 55 when the radiation unit 30 radiates electromagnetic waves into the insertion space 40 to heat an aerosol generating article.

Referring to FIGS. 1 to 4, in operation 351, the processor 170 may calculate the reflectance of electromagnetic waves.

The directional coupler 240 may be a passive element having a waveguide structure that may separate an incident wave from a reflected wave. The directional coupler 240 may receive an RF signal transmitted from the power amplifier 230 toward the radiation unit 30 and an electromagnetic wave reflected from the insertion space 40 after being radiated by the radiation unit 30. The directional coupler 240 may separate the RF signal transmitted from the source unit 20 from the electromagnetic wave reflected from the insertion space 40 and transmit the separated waves to the processor 170.

The processor 170 may calculate the reflectance of an electromagnetic wave radiated into the insertion space 40 by using a value obtained by dividing a signal reflected from the insertion space 40 by an input signal. Specifically, the processor 170 may calculate the reflectance by using a value obtained by dividing an electromagnetic wave reflected from the insertion space 40 by an RF signal transmitted from the source unit 20. The processor 170 may calculate a reflectance at regular time intervals. The reflectance has the least value under the resonance condition by the insertion space 40. The processor 170 may monitor a change in reflectance over time and control an operation of the pump 55 based on the change in reflectance over time, and accordingly, a resonance frequency of the insertion space 40 may be maintained within an allowable range of a target resonance frequency.

In operation 352, the processor 170 may control an operation of the pump 55 based on the reflectance. Specifically, when the reflectance increases, the processor 170 may operate the pump 55 to supply a liquid composition to the insertion space 40. That is, when the reflectance differentiated with respect to time is greater than zero, the processor 170 may operate the pump 55 (operation 353). When the reflectance increases, the amount of dielectric included in an aerosol generating article inserted in the insertion space 40 is consumed by microwave heating to gradually deviate from a resonance condition, and accordingly, the reflectance may be regarded as being increased. By operating the pump 55 to supply a liquid composition to the insertion space 40, a resonance frequency of the insertion space 40 may be maintained at a target value (that is, the reflectance may be reduced).

In addition, when the reflectance decreases (that is, the reflectance differentiated with respect to time is less than 0), the amount of dielectric included in an aerosol generating article inserted in the insertion space 40 is consumed by microwave heating, and accordingly, the permittivity of the insertion space 40 may be regarded as approaching a resonance condition. Therefore, in this case, it is preferable to control the pump 55 such that a liquid composition is not supplied to the insertion space 40.

In operation 353, the amount of liquid composition supplied to the insertion space 40 may be determined by totally considering the rate of increase in permittivity and reflectance of a liquid composition included in the liquid reservoir 50. Specifically, the processor 170 may control an operation of the pump 55 such that the amount of liquid composition supplied to the insertion space 40 is proportional to the reflectance differentiated with respect to time.

In operation 354, when the capacitance of the insertion space 40 is greater than a third threshold, the processor 170 may stop the operation of the pump 55 to stop supplying the liquid composition to the insertion space 40 (operation 355). The third threshold is an upper limit of a target capacitance range. When the capacitance of the insertion space 40 is greater than the third threshold, it may be considered that the amount of liquid composition supplied to the insertion space 40 in operation 353 is excessive. When the liquid composition is supplied excessively to the insertion space 40, the permittivity of the insertion space 40 may gradually deviate from a resonance condition, and accordingly, it is preferable to stop an operation of the pump 55 to stop supplying the liquid composition.

As described with reference to operation 351 to operation 354, the processor 170 may control an operation of the pump 55 such that the permittivity of the insertion space 40 is maintained within a certain range while the radiation unit 30 radiates electromagnetic waves into the insertion space 40 to heat an aerosol generating article. As a result, a resonance frequency of the insertion space 40 may be maintained within an allowable range of a target resonance frequency while an aerosol generating device is in heating operation.

As described above with reference to FIGS. 1 to 4, the aerosol generating device according to an embodiment includes the insertion space 40 into which at least a part of an aerosol generating article is inserted, the source unit 20 that generates a radio frequency (RF) signal, the radiation unit 30 that radiates the RF signal in the form of an electromagnetic wave toward the aerosol generating article inserted in the insertion space 40, the liquid reservoir 50 including a liquid composition, the pump 55 that supplies the liquid composition from the liquid reservoir 50 to the insertion space 40, and the processor 170 that controls operations of the source unit 20 and the pump 55.

The processor 170 controls the operation of the pump 55 such that a resonance frequency of the insertion space 40 is maintained within an allowable range of a target resonance frequency.

The aerosol generating device further includes the capacitive sensor 60 that detects capacitance of the insertion space 40, wherein the processor 170 controls the operation of the pump 55 based on a sensed value of the capacitive sensor 60.

The processor 170 presets a target range of the capacitance to correspond to the target resonance frequency, and operate the pump 55 when the capacitance of the insertion space 40 is less than a lower limit of the target range.

The processor 170 controls the operation of the pump 55 such that an amount of the liquid composition supplied to the insertion space 40 is proportional to a difference between the capacitance of the insertion space 40 and the lower limit.

The processor 170 determines whether the aerosol generating article is inserted in the insertion space 40, based on the sensed value of the capacitive sensor 60.

When the aerosol generating article is determined to be inserted in the insertion space 40, the processor 170 causes the source unit 20 to transmit the RF signal to the radiation unit 30.

The processor 170 calculates a reflectance of the electromagnetic wave and control the operation of the pump 55 based on the reflectance.

When the reflectance differentiated with respect to time is greater than zero, the processor 170 operates the pump 55.

The processor 170 presets a target range of the capacitance to correspond to the target resonance frequency, and when the capacitance of the insertion space 40 is greater than an upper limit of the target range, the processor 170 stops the operation of the pump 55

The operation of the pump 55 is controlled such that an amount of the liquid composition supplied to the insertion space 40 is proportional to the differentiated capacitance.

The aerosol generating device further includes an input unit that receives information input by a user, wherein the processor 170 controls the operation of the pump 55 based on the information input to the input unit.

The aerosol generating device further includes an output unit that outputs information on the operation of the pump 55.

The aerosol generating device further includes a directional coupler that separates the RF signal transmitted from the source unit from an electromagnetic wave reflected from the insertion space 40 and transmit the separated signal to the processor 170.

An aerosol generating device according to an embodiment may supply a liquid composition to the insertion space 40 as needed while an aerosol generating device is in operation.

Also, the aerosol generating device may monitor the reflectance of an aerosol generating article while the aerosol generating article is heated, and supply a liquid composition to the insertion space 40 to maintain a resonance frequency within an allowable range of a preset target resonance frequency.

Also, the aerosol generating device may supply a liquid composition to the insertion space 40 through a user interface (UI), and accordingly, a user may experience a variety of smoking according to preference of the user.

Also, a liquid composition may be supplied based on the capacitance of an insertion space and the reflectance of a microwave while the aerosol generating device is in operation, and accordingly, the frequency satisfying a resonance condition of the insertion space may be managed within an allowable range of a preset target resonance frequency.

Effects of the embodiments are not limited to the effects described above, and undescribed effects may be clearly understood by a person having ordinary skill in the art to which the embodiments belong from the specification and the attached drawings.

Some embodiments or other embodiments of the disclosure described above are not exclusive or distinct from each other. In some embodiments or other embodiments of the disclosure described above, respective components or functions may be used in combination with one another or combined with one another.

For example, a component A described in a particular embodiment and/or drawing and a component B described in another embodiment and/or drawing may be combined with each other. In other words, even when coupling between components is not directly described, the coupling may be made except when the coupling is described as impossible.

The above description should not be construed as being limited in all respects but should be considered illustrative. The scope of the disclosure should be determined by the logical interpretation of appended claims, and all changes within the equivalent scope of the disclosure are included in the scope of the disclosure.

What is claimed is:

1. An aerosol generating device comprising:
an insertion space into which at least a part of an aerosol generating article is inserted;
a source unit configured to generate a radio frequency (RF) signal;
a radiation unit configured to radiate the RF signal in a form of an electromagnetic wave toward the aerosol generating article inserted in the insertion space;
a liquid reservoir storing a liquid composition;
a pump configured to supply the liquid composition from the liquid reservoir to the insertion space; and
a processor configured to control operations of the source unit and the pump.

2. The aerosol generating device of claim 1, wherein the processor is further configured to control the operation of the pump such that a resonance frequency of the insertion space is maintained within an allowable range of a target resonance frequency.

3. The aerosol generating device of claim 2, further comprising a capacitive sensor configured to detect capacitance of the insertion space,
wherein the processor is further configured to control the operation of the pump based on a sensed value of the capacitive sensor.

4. The aerosol generating device of claim 3, wherein the processor is further configured to preset a target range of the capacitance to correspond to the target resonance frequency and operate the pump when the capacitance of the insertion space is less than a lower limit of the target range.

5. The aerosol generating device of claim 4, wherein the processor is further configured to control the operation of the pump such that an amount of the liquid composition supplied to the insertion space is proportional to a difference between the capacitance of the insertion space and the lower limit.

6. The aerosol generating device of claim 3, wherein the processor is further configured to determine whether the aerosol generating article is inserted in the insertion space based on the sensed value of the capacitive sensor.

7. The aerosol generating device of claim 6, wherein, when the aerosol generating article is determined to be inserted in the insertion space, the processor is further configured to cause the source unit to transmit the RF signal to the radiation unit.

8. The aerosol generating device of claim 7, wherein the processor is further configured to calculate a reflectance of the electromagnetic wave and control the operation of the pump based on the reflectance.

9. The aerosol generating device of claim 8, wherein, when the reflectance differentiated with respect to time is greater than zero, the processor is further configured to operate the pump.

10. The aerosol generating device of claim 9, wherein the processor is further configured to preset a target range of the capacitance to correspond to the target resonance frequency, and when the capacitance of the insertion space is greater than an upper limit of the target range, the processor is further configured to stop the operation of the pump.

11. The aerosol generating device of claim 9, wherein the operation of the pump is controlled such that an amount of the liquid composition supplied to the insertion space is proportional to the differentiated capacitance.

12. The aerosol generating device of claim 1, further comprising an input unit configured to receive information input by a user,
wherein the processor is further configured to control the operation of the pump based on the information input to the input unit.

13. The aerosol generating device of claim 12 further comprising an output unit configured to output information on the operation of the pump.

14. The aerosol generating device of claim 8, further comprising a directional coupler configured to separate the RF signal transmitted from the source unit from an electromagnetic wave reflected from the insertion space and transmit the separated RF signal to the processor.
